(19) United States
(12) Patent Application Publication
(10) Pub. No.: US 2022/0212357 A1
(43) Pub. Date: Jul. 7, 2022

(54) FOLDING KNIFE (VARIANTS)

(71) Applicant: Igor Vladimirovich PONOMAREV, G. Snezhinsk (RU)

(72) Inventor: Igor Vladimirovich PONOMAREV, G. Snezhinsk (RU)

(21) Appl. No.: 17/605,513

(22) PCT Filed: Oct. 29, 2020
(86) PCT No.: PCT/RU2020/050075

§ 371 Date: Oct. 21, 2021

(30) Foreign Application Priority Data
Apr. 22, 2019 (RU) 2019112224
Apr. 22, 2019 (RU) 2019112225

(51) Int. Cl. B26B 1/04

(52) U.S. Cl. CPC B26B 1/048

(57) ABSTRACT

A folding knife comprises a blade 1 which has a pin 9 and is pivotally fastened to a locking plate 2 having an aperture for a pivot bushing. In a first variant, the folding knife comprises a pivot bushing 3 with a flange 4. In a second variant, the knife has a pivot bushing 17 with a flange 18, and, on the opposite side of the blade 1, there is a clamping bushing 19 with a flange 20, which interacts with the pivot bushing 17 by means of a tight fit. A tightening screw 7 is screwed into the pivot bushing 3 or 17. Mounted on both sides of the blade 1, on the pivot bushing 3 or 17, are washers 5 and 6 made of an anti-friction elastically deformable material having a compressive elastic modulus of not less than 800 MPa. The locking plate 2 and a cover plate 8 are fastened by the insertion of fastening screws 12 into corresponding apertures 13. A backspacer 11 is mounted in the gap between the plates 2 and 8. A liner 10 is mounted in the lower portion of the locking plate 2. The technical result is simpler assembly, an increased lifespan as a result of more efficient compensation of lateral and torsional forces on the blade, and repairability.

### FIELD OF THE INVENTION

The invention relates to the hand-held cutting tools, in particular to the design of folding knives, mainly for household purposes.

### BACKGROUND OF THE INVENTION

A hobo knife is known consisting of a blade and a handle, connected with the possible folding-unfolding features by turning relative to the pivot pin, fixed in the handle, and fixation in the operating position. On the inner side of the handle there is a segmented driving slot with a retainer part, and a pin is fixed in it, while on the outer side of the blade, a frame is pressed onto the pin, in the axial groove of which a pivot pit is placed (utility model patent No. RU180255, Jun. 7, 2018).

Another folding knife is known consisting of a blade with a thrust roller and a recess, a shutter with an axis fixed between the right-side plate and the left-side plate, and a coil spring. On one side of the shutter axis, a thread is cut with a recess for a coil spring. The knife is equipped with the bushings, one of which is threaded for screwing onto the shutter axis thread and is located in the left-side plate, the other bushing is located in the right-side plate. The coil spring is fixed with one end in the left-side plate, with the other in the shutter made with a radial part, and the identical oblique cuts are made at an angle of 3-15 degrees in the blade recess and on the shutter radial part (patent for invention RU No. 2634814, Nov. 3, 2017).

As a result of patent research, the following technical solutions have been found that are relevant to this topic and have been considered by the applicant when analyzing and identifying a set of essential features: PCT/US2018/047776, CN 208409928, EP 2663430, U.S. Ser. No. 14/759,216.

The closest technical solution selected by the applicant as a prototype is a folding knife comprising a blade pivotally connected to a handle consisting of two plates, and the blade and one handle plate are mounted on a pivot pin, to which a washer adjoins on one side. The retention screw is mounted into the pivot pin that pulls together two handle plates with the blade, the latter can be fixed in the operating position (U.S. Ser. No. 14/197,120, Sep. 4, 2014).

In the known design, the blade is pulled together by two handle plates that reduces the knife durability, since in the case of frequent use, opening and closing, the lateral and torque forces on the blade lead to a gradual wear of a number of parts, contamination of the mechanism. As a result, periodic maintenance and adjustment are required. However, in the case of the plate adjustment and pulling, the alignment of wear surfaces is disturbed that entails a number of negative consequences, such as increased wear of a number of parts, blade play relative to the handle that can also lead to a decrease in the blade fixation reliability both in the open and closed position.

When assembling such a folding knife, a high tightening accuracy of two plates is required to ensure the necessary easy blade movement in the absence of plays and, as a result, the need for the most accurate manufacturing of structural parts and finishing fit to ensure the alignment of wear surfaces of the blade and antifriction elements, gaps between the blade and the plates. This leads to the increased labor costs and an increase in the number of specialized workers to assemble a high-quality folding knife, making it difficult to set up, maintain or repair it during the operation period.

### SUMMARY OF THE INVENTION

The objective of the present invention is to simplify the knife assembly while increasing its durability during the period of operation.

The achieved technical result is simpler assembly, an increased lifespan as a result of more efficient compensation of lateral and torsional forces on the blade, and repairability.

An additional technical result is the possible manual adjustment of the hinge joint in the case of wear and tear or replacement of skid washers with the long-term alignment of the wear surfaces and adjustment of the blade stroke in a fairly wide range without any plays.

### BRIEF DESCRIPTION OF THE DRAWINGS

FIG. 1 shows the inventive folding knife of claim No. 1 in a disassembled condition with the open blade position;

FIG. 2 schematically shows the hinge joint of a folding knife according to claim No. 1 assembled in such a way when the pivot bushing flange interacts with the outer surface of the locking plate;

FIG. 3 shows the same as FIG. 2, when the pivot pit flange is mounted deeply into the outer surface of the locking plate, and the pivot bushing rod has a threaded connection with the locking plate body;

FIG. 4 shows the same as FIG. 3, but when the pivot bushing flange is mounted on the inner side of the locking plate, and the pivot bushing has a tight fit due to pressing-in;

FIG. 5 shows the same as FIG. 3, but when the tightening screw is equipped with a centralizer;

FIG. 6 shows the same as FIG. 5, but when the pivot bushing flange interacts with the outer surface of the locking plate;

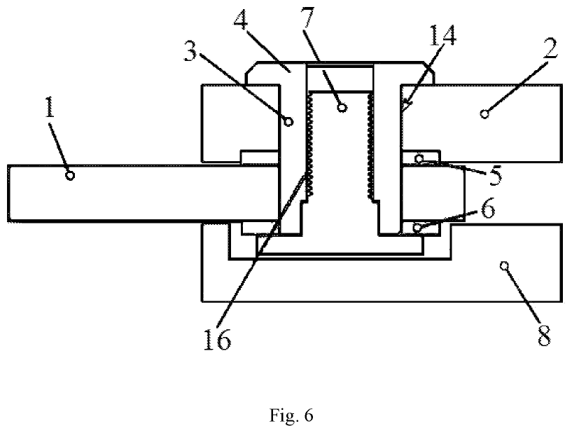

FIG. 7 shows the same as FIG. 5, but when the sleeve is made flush with the outer surface of the locking plate that is equipped with a fixing plate (liner);

FIG. 8 shows the same as FIG. 6, but when the tightening screw is made with a countersunk head that is brought out into a cover plate.

FIG. 9 shows the inventive folding knife according to claim No. 2 in the disassembled form with the open blade position;

FIG. 10 schematically shows the hinge joint of a folding knife according to claim No. 2 assembled in such a way that the tightening screw head interacts with the outer surface of the locking plate, and the pivot bushing flange interacts with the inner surface of the locking plate;

FIG. 11 shows the same as FIG. 10, when the pivot bushing flange and the tightening screw head interact with the outer surface of the locking plate;

FIG. 12 shows the same as FIG. 11, but when the pivot bushing flange and the tightening screw head are recessed into the locking plate.

### DETAILED DESCRIPTION

The technical problem is resolved by the fact that a folding knife according to embodiment 1 is shown comprising a blade pivotally connected to the handle by a pivot bushing with a flange, a tightening screw with a head and a washer, and with possible fixation in the operating position, while the handle consists of a locking plate and a cover plate, detachably attached to the locking plate with a gap between them for the blade movement, distinctive in that the pivot bushing flange interacts with the locking plate surface, an additional washer is mounted on the pivot bushing, and the said washers are made of anti-friction elastically deformable material and mounted on the pivot bushing on both sides of the blade.

The washers interacting with the blade surfaces on the right and left sides are made of anti-friction elastically deformable material with a modulus of compression elastic deformation of not less than 800 MPa. The modified polytetrafluoroethylene, for example, F4K15M5 grade or Fluvis series composite fluoroplastic, specified by the high wear resistance, low unlubricated friction coefficient, chemical resistance, required modulus of elastic deformation and almost complete absence of wear of the mating surface can be used as the anti-friction elastically deformable material.

The handle has a second plate that is detachably attached to the locking plate surface and is used an add-on element (cover plate). The cover plate can be detachably fixed to the locking plate by any known means with a gap required for the free blade movement. The cover plate can be attached to the locking plate, for example, by the threaded screws and an insert between the plates (a backspacer or a stack bolt) that ensure reliable mutual fixation of the plates with due regard to the gap size required for the free blade movement. When assembling the knife, the gap size is set considering the possible wear of the washers and prevention of the plates touching the blade. Moreover, if the gap between the cover plate and locking plate is exceeded, this does not in any way affect the normal operation of the folding knife, since the blade, by a hinge joint, is cantilevered to the locking plate only, while making a uniform structure, and the blade is freely moving around the pin that is a part of the hinge joint. In the case of partial wear of the washers (occurrence of plays), the normal folding knife operation is restored by adjusting the tightening screw by pressing the washers in a sufficiently wide range without plays, while only the cover plate is dismantled for the adjustments and no detailed disassembly of the knife is required.

The pivot bushing flange on one side can interact with the outer side of the locking plate, and such interaction can be performed both by placing the flange outside the locking plate outer surface, and by placing the flange at the recess depth. The pivot bushing flange can be placed in such a way that it interacts with the locking plate inner surface, while such interaction can be made by interaction of the flange surface with the locking plate inner surface to the recess depth, with due regard to the washer thickness and the desired gap between the blade and the plate.

The tightening screw with its rod interacts with the inner cavity of the pivot bushing, and its head interacts with the washer that, in turn, interacts with the blade surface. The recess is made on the inside of the cover plate for the tightening screw head.

Additionally, the folding knife is equipped with a liner located in the lower portion of the locking plate that is made as a spring-loaded fixing plate that reliably retains the blade in the open position and prevents the risk of accidental closing and opening of the knife.

When aligning the locking plate and the cover plate and their attachment by the fasteners, the folding knife is additionally equipped with a backspacer that is a spacer in the gap formed between the plates in the upper handle part.

The blade is equipped with a pin that serves as a stop and is designed to limit the motion trajectory of the blade.

Additionally, to increase the knife reliability and operating life, the hinge joint of the present folding knife may comprise a centralizer for a transitional fit for the tightening screw. The locking plate may additionally comprise a fixing plate, pressings or threading and other additional elements.

The claimed design of a folding knife provides a simple assembly during its manufacturing process, and maintainability and durability in the process of its operation.

Comparison of the proposed technical solution with the prototype shows the following differences:
the hinge joint of the blade is connected to only one plate performing the function of the locking plate, while the blade is fastened to the locking plate by a tightening screw;
the pivot bushing has a flange on one side that interacts with the locking plate surface;
an additional washer is mounted on the pivot bushing that interacts with the blade surface in such a way that the washers mounted on the pivot bushing are placed on the left and right sides of the blade;
the handle plates are detachably connected to each other;
the washers are made of anti-friction elastically deformable material.

The technical problem is also resolved by the fact that a folding knife according to embodiment 2 is shown comprising a blade pivotally connected to the handle by a pivot bushing with a flange, a tightening screw with a head and a washer, with the possible fixation in the operating position, while the handle consists of a locking plate and a cover plate, detachably attached to the locking plate with a gap between them for the blade movement. It is distinctive in that it is equipped with a clamping bushing with a flange, connected to the pivot bushing, and an additional washer, while the said washers are made of anti-friction elastically deformable material and are mounted on the pivot bushing on both sides of the blade, the pivot bushing flange and the tightening screw head are located on one side of the blade, the pivot bushing flange is adjacent to the locking plate, and the tightening screw is screwed into the clamping bushing, the flange of which is fixed in the cover plate, while ensuring interaction with one of the washers.

The washers interacting with the blade surfaces on the right and left sides are made of anti-friction elastically deformable material with a modulus of compression elastic deformation of at least 800 MPa. The antifriction materials are specified by an almost complete absence of wear of the mating surface. The modified polytetrafluoroethylene, for example, F4K15M5 grade or Fluvis series composite fluoroplastic, specified by the high wear resistance, low unlubricated friction coefficient, chemical resistance, and required modulus of elastic deformation can be used as the anti-friction elastically deformable material.

The handle has a locking plate and a second plate that is detachably attached to the locking plate surface and is used as an add-on element (cover plate). The cover plate can be detachably fixed to the locking plate by any known means with a gap necessary for the free blade movement. The cover plate can be attached to the locking plate, for example, by the threaded screws and an insert between the plates (a backspacer or a stack bolt) that ensure reliable mutual fixation of the plates with due regard to the gap size required for the free blade movement. When assembling the knife, the gap size is set considering the possible wear of the washers and prevention of the plates touching the blade. Moreover, if the gap between the cover plate and locking plate is exceeded, this does not in any way affect the normal operation of the folding knife, since the blade, by a hinge joint, is cantilevered to the locking plate only, while making a uniform structure, and the blade is freely moving around the pin that is a part of the hinge joint. In the case of partial wear of the washers (occurrence of plays), the normal folding knife operation is restored by adjusting the tightening screw by pressing the washers in a sufficiently wide range without plays, while only the cover plate is dismantled for the adjustments and no detailed disassembly of the knife is required.

The clamping bushing flange can also have various shapes (for example, an oval) that allows it to be fixed in the cover plate recess for adjustment without disassembling the knife.

The tightening screw and the pivot bushing are located on one side of the blade and can interact with the locking plate, and such interaction can be performed both by placing the pivot bushing flange on the inner surface of the locking plate at the recess depth of the locking plate with due regard to the washer thickness and the desired gap between the blade and the plate, and the tightening screw head on the outer surface of the locking plate, as well as by placing the tightening screw head and the pivot bushing flange on the outer surface of the locking plate in the recess with due regard to reliable fixation of the pivot bushing (pressing-in or threaded connection).

The tightening screw with its rod interacts with the inner cavity of the clamping bushing that is mounted on the other side of the blade, and interacts by its outer pivot bushing with the inner pivot bushing by tightly fitting the clamping bushing in the pivot bushing. The clamping bushing is equipped with a flange that faces the cover plate.

Additionally, the folding knife is equipped with a liner located in the lower portion of the locking plate that is a spring-loaded fixing plate that reliably retains the blade in the open position and prevents the risk of accidental closing and opening of the knife.

When aligning the locking plate and the cover plate and their attachment by the fasteners, the folding knife is additionally equipped with a backspacer that is a spacer in the gap formed between the plates in the upper handle part.

The blade is equipped with a pin that serves as a stop and is designed to limit the motion trajectory of the blade.

Additionally, to increase the knife reliability and operating life, the hinge joint of the present folding knife may comprise a centralizer for a transitional fit for the tightening screw. The locking plate may additionally comprise a fixing plate, pressings or threading and other additional elements.

Comparison of the proposed technical solution according to embodiment 2 with the prototype shows the following differences:
the hinge joint of the blade is connected only to one plate used as the locking plate, while the blade is fastened to the locking plate by the tightening screw and clamping bushing with a flange;
the tightening screw and the pivot bushing are located on one side of the blade and adjoin the locking plate;
the clamping bushing connected to the pivot bushing is located on the other side of the blade;
the pivot bushing is equipped with a flange that interacts with the locking plate;
two washers are mounted on the pivot bushing on the left and right sides of the blade, interacting with the blade surface;
the clamping bushing flange interacts with the washer;
the handle plates are detachably connected to each other;
the washers are made of anti-friction elastically deformable material.

The cantilever structure of the locking plate and composition of the hinge joint, in conjunction with the washer manufacturing material, provide the claimed technical result. The claimed variants of a folding knife are interconnected by a single inventive concept based on the fact that a feature of the claimed designs is that the folding knives comprise an additional washer, while the main and additional washers are placed on both sides of the blade on the pivot bushing and are made of anti-friction elastically deformable material, preferably with a modulus of compression elasticity of at least 800 MPa.

As far as is known, the washers made of bronze or brass are widely used in the folding knives, the disadvantage of which is their rapid wear and high unlubricated friction coefficient, comprehensive adjustment and, as a result, quick failure or the need for regular maintenance. When used in the hinge joint, a special lubricant is required. The use of fluoroplastic washers in a folding knife has also shown certain drawbacks due to the creep and cold flow of this material. The above features of the claimed knife design and the washer manufacturing material, namely the anti-friction elastically deformable material with a modulus of compression elasticity of at least 800 MPa provide the claimed technical result, i.e. eliminate a significant number of disadvantages that are inherent in the known designs of folding knives.

### BEST MODES FOR CARRYING OUT THE INVENTION

The following variants of the present invention are use as an example only with reference to the attached drawings.

The drawings schematically show the inventive device (variants). Variants of invention according to claim No. 1.

The folding knife comprises a blade 1 that is pivotally attached to the locking plate 2. Moreover, the blade 1 and the locking plate 2 are mounted on the pivot bushing 3 that has a flange 4 interacting with the locking plate 2 that has an opening for the pivot bushing rod 3. On both sides of the blade 1 the washers 5 and 6 are mounted on the pivot bushing 3 with preferable thickness of at least 1.35 mm, made of an anti-friction elastically deformable material that is preferably a composite fluoroplastic having a modulus of compression elasticity of at least 800 MPa. A tightening screw 7 is screwed into the pivot bushing 3, the head of which is facing the cover plate 8. The cover plate 8 is detachably attached to the locking plate 2, while forming a handle, a spacer 11 (backspacer) can be mounted in the gap between the plates 2 and 8 that is located in the upper handle part. The blade 1 is equipped with a pin 9 used as a stop to limit the stroke. The locking plate 2 comprises a liner 10 (a spring-loaded fixing plate) that is located in the lower portion of the locking plate 2. The cover plate 8 has openings for the attaching screws 12 used for connection of the cover plate 8 to the locking plate 2 that has corresponding apertures 13. Additionally, the pivot bushing 3 and the locking plate 2 can be made with a tight fit achieved by pressing-in 14, providing lug connection between the pivot bushing 3 and the locking plate 2. Additionally, the tightening screw 7 can be provided with an alignment possibility in the form of a centralizer 15 that increases the fit accuracy and reliability of the hinge joint.

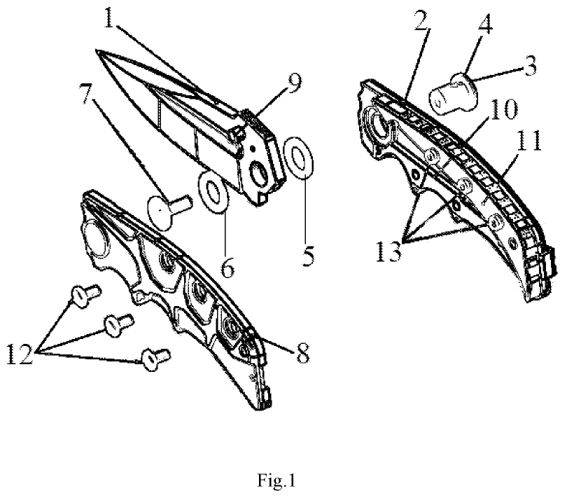

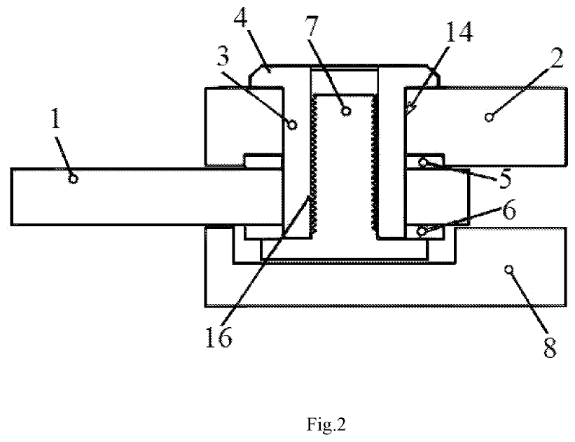

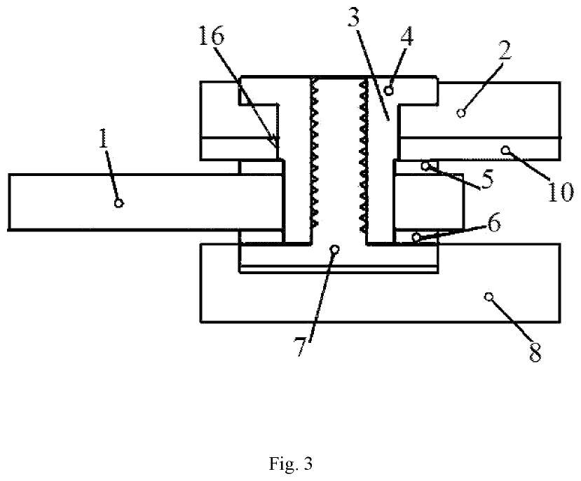

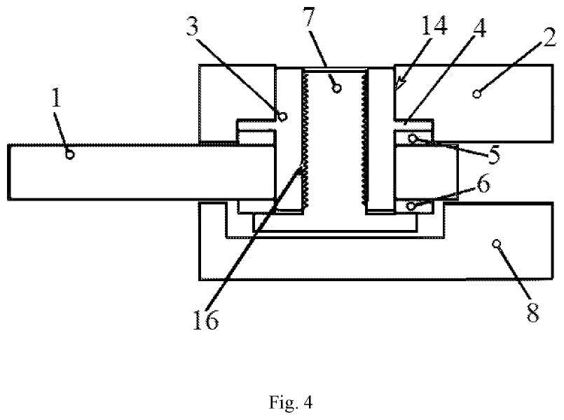

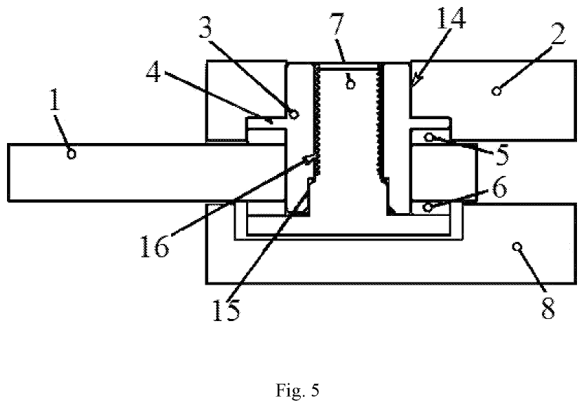

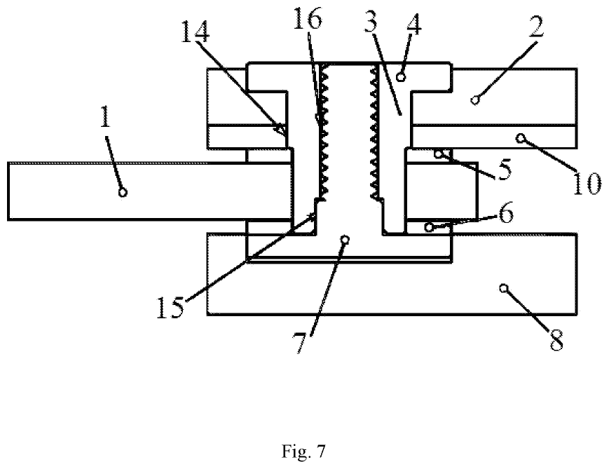

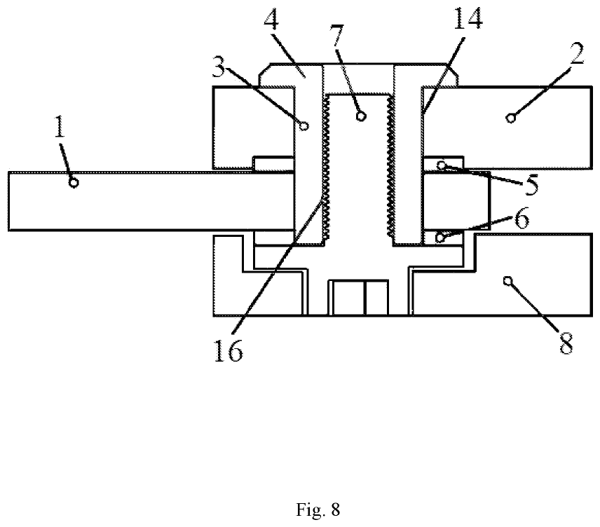

The folding knife is assembled by making the hinge joint on the locking plate 2 with sequential installation in the locking plate 2 opening of the pivot bushing 3, flange 4 that interacts with the locking plate 2, then placing the washer 5, blade 1 and washer 6 on the pivot bushing rod 3 that are pulled together by the tightening screw 7 screwed into the pivot bushing rod 3 by a threaded connection 16. If necessary, a liner 10 is attached to the locking plate (FIG. 3 and FIG. 7). The cover plate 8 is fastened by the attaching screws 12 and openings 13 to the locking plate 2, and the gap formed between the plates 2 and 8 is closed by a backspacer 11. To increase the hinge joint rigidity, the tightening screw 7 can be made with a centralizer 15 (FIG. 5 and FIG. 7) for a transitional fit with the pivot bushing 3. Such a connection allows to more accurately and evenly redistribute the torque and lateral load on the blade 1 from the skid washers 5 and 6 that increases the operating life of the axial assembly (hinge joint). The tightening screw 7 with a countersunk head (FIG. 8) that is brought out into the cover plate 8, allows to adjust the hinge joint without removing the cover plate 8. Installation of the flange 4 from the outer surface of the locking plate 2 (FIG. 1, FIG. 2, FIG. 5 and FIG. 8) or with penetration into the locking plate body (FIG. 3) or flush with it (FIG. 7) or in the immediate vicinity to the inner surface (FIG. 4 and FIG. 5) provide the same technical result and are examples of possible location of the flange 4 of the pivot bushing 3 relative to the locking plate 2.

Variants of invention according to claim No. 2.

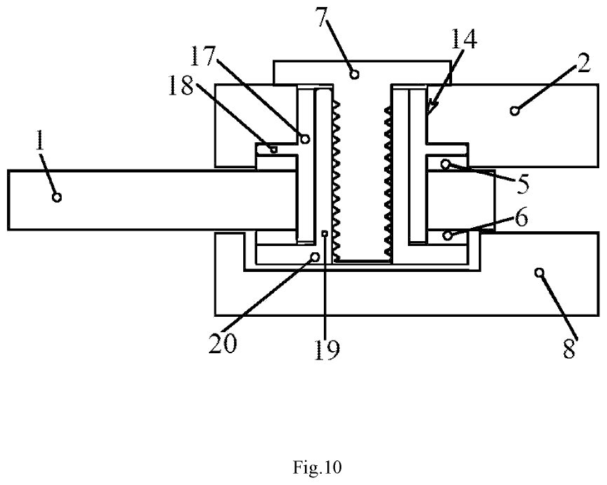

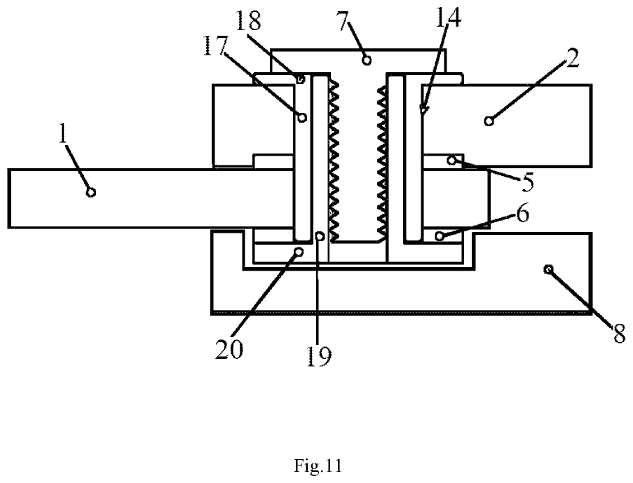

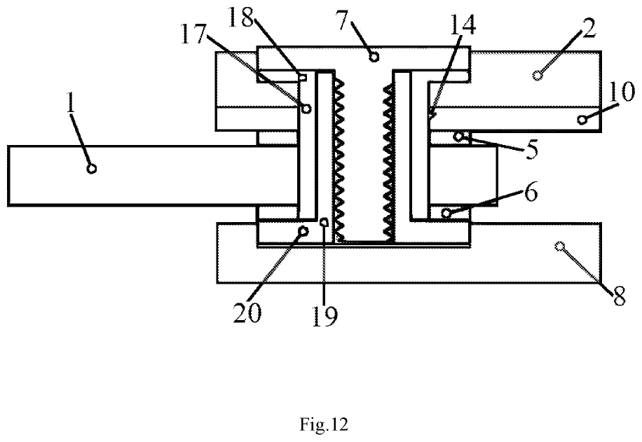

The folding knife comprises a blade 1 that is pivotally attached to the locking plate 2. Moreover, the blade 1 and the locking plate 2 are mounted on the pivot bushing 3 that has a flange 4 interacting with the locking plate 2 that has an opening for the pivot bushing rod 3. On both sides of the blade 1 the washers 5 and 6 are mounted on the pivot bushing 3 with preferable thickness of at least 1.35 mm, made of an anti-friction elastically deformable material that is preferably a composite fluoroplastic having a modulus of compression elasticity of at least 800 MPa. A tightening screw 7 is screwed into the pivot bushing 3, the head of which is adjacent to the outer surface of the locking plate (FIG. 10) or adjoins the flange surface 18 of the pivot bushing 17 interacting with the outer surface of the locking plate 2 (FIG. 11) or the tightening screw head 7 together with a flange 4 of the pivot bushing 3 is recessed into the locking plate 2 (FIG. 12).

The clamping bushing 19 with a flange 20 is located on the other side of the blade while interacting with the pivot bushing 17 by a tight fit, and the tightening screw rod 7 is placed in the clamping bushing cavity 19. The clamping bushing 19 allows redistributing the lateral or torque force on the blade 1 over a large area of the pivot bushing 17. The flange 20 of the pivot bushing 19 faces the cover plate 8.

The cover plate 8 is detachably attached to the locking plate 2, while forming a handle. A spacer 11 (backspacer) can be mounted in the gap between the plates 2 and 8 that is located in the upper handle part. The blade 1 is equipped with a pin 9 used as a stop to limit the stroke. The locking plate 2 comprises a liner 10 (a fixing plate) that is located in the lower portion of the locking plate 2. The cover plate 8 has openings for the attaching screws 12 used for connection of the cover plate 8 to the locking plate 2 that has corresponding apertures 13. The pivot bushing 3 and the locking plate 2 can be made with a tight fit achieved by pressing-in 14 or threading 16, providing lug connection between the pivot bushing 17 and the locking plate 2.

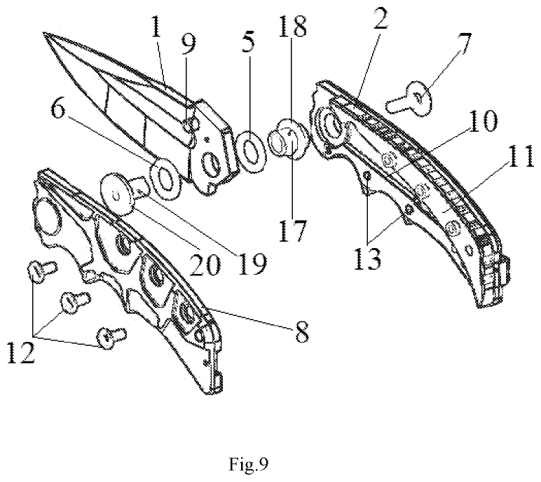

The folding knife is assembled by making the hinge joint on the locking plate 2 with sequential installation in the locking plate 2 opening of the pivot bushing 17 with the flange 18 that interacts with the locking plate 2, then placing the washer 5, blade 1, washer 6 and clamping bushing 19 with the flange 20 on the pivot bushing rod 17 that are pulled together by the tightening screw 7 screwed into the pivot bushing opening 19 by a threaded connection. If necessary, a liner 10 is attached to the locking plate (FIG. 9, 12). The cover plate 8 is fastened by the attaching screws 12 and openings 13 to the locking plate 2, and the gap formed between the plates 2 and 8 is closed by a backspacer 11. Installation of the tightening screw head 7 and flange 18 of the pivot bushing 17 on the inner or outer surface of the locking plate 2 or with recess in the locking plate 2 provides the same technical result and is example of arrangement of the hinge joint elements in relation to each other.

### INDUSTRIAL APPLICABILITY

The claimed technical solution can be made using well-known technological processes, therefore, it meets the criterion of “industrial applicability”.

Experimental data show that the use of antifriction elastically deformed washers, preferably with a compressive modulus of at least 800 MPa, allows maintaining the alignment of the operating contact surfaces of the blade and handle in the case of prolonged use of the knife, especially with frequent opening and closing, as well as with various lateral loads, when applying torque moments to the blade during work with dense materials. Moreover, such washers make it possible to ensure the possible adjustment of the hinge joint in the case of wear while maintaining the alignment of the wear surfaces without additional adjustment. Moreover, the claimed design allows not only the load redistribution on the entire axial assembly (hinge joint), but also increases the hinge joint rigidity that affects the operating life and reliability of the folding knife. Thus, the claimed utility model can increase the knife durability by 15-17%.

The inventive design allows to simultaneously ensure ease of assembly, since the use of antifriction elastically deformed washers eliminates stringent requirements for fitting, grinding, i.e. allow them to be used without finishing adjustment with the usual tolerances in the case of manufacture on modern equipment that significantly reduces the need for highly skilled manual operations during assembly, but does not lead to a loss in the assembly quality. The tolerances only affect the blade position relative to the handle, but not its performance, i.e. the high adaptability of the folding knife assembly, as well as its improved maintainability is ensured.

1. A folding knife containing a blade pivotally connected to the handle by a pivot bushing with a flange, a tightening screw with a head and a washer, and made with the possible fixation in the operating position, while the handle comprises a locking plate and a cover plate, detachably attached to the locking plate with a gap between them for the blade movement, distinctive in that the pivot bushing flange interacts with the locking plate surface, an additional washer is mounted on the pivot bushing, while the said washers are made of anti-friction elastically deformable material and are mounted on the pivot bushing on both sides of blade.

2. A folding knife of claim 1, distinctive in that the washers are made of an anti-friction elastically deformed material with a modulus of compression elastic deformation of at least 800 MPa.

3. A folding knife of claim 1, distinctive in that the pivot bushing flange interacts with the outer side of the locking plate.

4. A folding knife of claim 1, distinctive in that the pivot bushing flange is made flush with the locking plate.

5. A folding knife of claim 1, distinctive in that the pivot bushing flange interacts with the inner surface of the locking plate.

6. A folding knife of claim 1, distinctive in that the tightening screw is made with a centralizer for a transitional fit with a pivot bushing.

7. A folding knife of claim 1, distinctive in that the tightening screw is made with a countersunk head that is exposed in a cover plate.

8. A folding knife of claim 1, distinctive in that the blade can be fixed in the operating position using a spring-loaded fixing plate located in the lower portion of the locking plate.

9. A folding knife, containing a blade pivotally connected to the handle by a pivot bushing with a flange, a tightening screw with a head and a washer, and made with the possible fixation in the operating position, while the handle comprises a locking plate and a cover plate detachably attached to the locking plate with a gap between them for the blade movement, distinctive in that it is equipped with a clamping bushing with a flange connected to the pivot bushing, and an additional washer, while the said washers are made of anti-friction elastically deformable material and are mounted on the pivot bushing on both sides of the blade, the pivot bushing flange and the tightening screw head are located on one side of the blade, the pivot bushing flange is adjacent to the locking plate, and the tightening screw is screwed into the clamping bushing, the flange of which is fixed in the cover plate, while ensuring interaction with one of the washers.

10. A folding knife of claim 9, distinctive in that the washers are made of anti-friction elastically deformable material with a modulus of compression elastic deformation of at least 800 MPa.

11. A folding knife of claim 9, distinctive in that the clamping bushing flange is made with a shape that ensures its fixation in the recess made in the cover plate.

12. A folding knife of claim 9, distinctive in that the pivot bushing flange is adjacent to the inner surface of the locking plate, and the tightening screw head is adjacent to the locking plate from its outer side.

13. A folding knife of claim 9, distinctive in that the tightening screw head and the pivot bushing flange are adjacent to the locking plate from its outer side.

14. A folding knife of claim 9, distinctive in that the locking plate is made with a recess, and the tightening screw head and the pivot bushing flange are placed therein.

15. A folding knife of claim 9, distinctive in that the blade can be fixed in the operating position by means of a spring-loaded fixing plate located in the lower portion of the locking plate.

16. A folding knife of claim 9, distinctive in that the gap formed between the handle plates is made by a backspacer.
